(19) United States
(12) Patent Application Publication
(10) Pub. No.: US 2026/0228730 A1
(43) Pub. Date: Aug. 6, 2026

(54) Multi-party Computation System

(71) Applicant: Crossbar, Inc., Santa Clara, CA (US)

(72) Inventors: Sung Hyun Jo, Sunnyvale, CA (US); Mark Edward Davis, Carlsbad, CA (US); Ker Zhang, Los Gatos, CA (US)

(21) Appl. No.: 19/236,857

(22) Filed: Jun. 12, 2025

Related U.S. Application Data
(60) Provisional application No. 63/754,410, filed on Feb. 5, 2025.

(51) Int. Cl. G06Q 20/40; G06Q 20/36

(52) U.S. Cl. CPC G06Q 20/401; G06Q 20/367

(57) ABSTRACT

A multi-party computation (MPC) system includes a central device and a plurality of peripheral devices. The central device may include a secure processing unit (SPU) configured to execute a plurality of MPC algorithms and process one or more MPC functions, and a MPC-enabled software application executable by the SPU to perform the one or more MPC functions according to a specific MPC algorithm. Each peripheral device may include at least the MPC-enabled software application. The central device may be configured to register one or more peripheral devices, send a request to each of the one or more peripheral devices to perform a specific MPC function, receive, from each of the one or more peripheral devices, a confirmation of the request; and perform the specific MPC function according to the specific MPC algorithm.

### PRIORITY

This application claims the benefit, under 35 U.S.C. § 119(e), of U.S. Provisional Patent Application No. 63/754,410, filed 5 Feb. 2025, which is incorporated herein by reference.

### TECHNICAL FIELD

This disclosure generally relates to an improved multi-party computation (MPC) system. In particular, the disclosure relates to a MPC system including a central device and one or more peripheral devices for performing MPC functions and/or operations.

### BACKGROUND

Multi-Party Computation (MPC) is an advanced cryptographic technique that enables multiple parties/devices to collaboratively compute a function over their inputs while keeping those inputs private from one another. MPC is emerging as a critical technology to enhance security, privacy, and functionality, such as in the fields of digital wallets, cryptocurrency storage, decentralized finance, and multi-device wallets.

In an MPC, two or more devices and/or parties (e.g., users) may jointly compute a function and sign a cryptographic transaction, such as spending a cryptocurrency or transferring a cryptocurrency to a particular address. The devices and/or parties may compute the function and/or sign a transaction using their respective key shares (e.g., private key shares) that may be generated during a key generation process.

In a traditional MPC setup, key shares may be stored at varying locations and/or devices, which may be located far away from each other. For example, a first key share may be stored in a hardware wallet, a second key share may be stored in a user's desktop computer, and a third key share may be stored on a cloud. While specialized hardware exists to serve as MPC shareholders, it has no independent utility. As a result, users typically do not carry them around. When a user wants to perform a MPC operation and/or function (e.g., signing a transaction), the user needs to be at a certain fixed location (e.g., at their home) in order to perform the MPC operation. This can be inconvenient when the user is away from their typical storage location. With a traditional MPC setup, the user cannot perform a MPC operation on the fly. Also, the devices involved in the traditional MPC setup may all be “hot” devices (e.g., devices with internet connectivity), which makes them vulnerable to online attacks or cyberattacks.

Accordingly, there is a need for an improved MPC system that enables securely and efficiently performing MPC operations on the go and/or remotely without needing a shareholder (e.g., user) to be a certain fixed location. Also, there is a need for a MPC system that can circumvent online attacks or cyberattacks.

### SUMMARY OF PARTICULAR EMBODIMENTS

Particular embodiments described herein relate to an improved MPC system including a central device and a plurality of peripheral devices. These peripheral devices may be commonly used and carried by users and are enabled to serve as MPC shareholders. Such peripheral devices may include, for example, wearable devices, such as smartwatch, earphones, etc. These peripheral devices have utility other than serving as a MPC shareholder and are commonly carried by users. The MPC system discussed herein may of T-of-N configuration, where T is threshold or minimum number of MPC shareholder devices that may be required to create a valid signature, and N is a total number of shareholder devices. The shareholder devices may be any devices, provided that N is at least greater than or equal to two devices, and at least one central-type device with internet connectivity must always exist to execute an MPC operation/function (e.g., key generation, signing).

In particular embodiments, the central device may include a secure processing unit (SPU) and an MPC-enabled software application. The SPU may be configured to store key share(s), execute a plurality of MPC algorithms, and process one or more MPC functions/computations (e.g., transaction signing, key generation) discussed herein. In particular embodiments, the SPU integrates a micro-controller unit (MCU) and a hardware secure element (SE) into a single monolithic chip, which enhances overall security and enables faster MPC computations. In particular embodiments, the central device may further include an MPC-enabled software application. The MPC-enabled software application is an MPC-specific application that is executable by the SPU to perform the one or more MPC functions/operations (e.g., transaction signing, key generation) according to a specific MPC algorithm. The MPC-enabled software application may be downloaded from an application store. The peripheral devices may also include an instance of the MPC-enabled software application. In particular embodiments, each peripheral device may include a specific instance or version of the MPC-enabled software application that is custom tailored or developed according to a specific type of the peripheral device. In some embodiments, one or more of the peripheral devices may additionally include the SPU.

In particular embodiments, the central device and the peripheral devices may be associated with a single user. By way of an example and without limitation, the central device may be user's smartphone and the peripheral devices may be user's wearable devices. In particular embodiments, the central device and the plurality of peripheral devices may be located within a short range of each other. For example, the plurality of peripheral devices may be connected to the central device via Bluetooth or near-field communication (NFC) that enables the peripheral devices to communicate with the central device over short range or distances.

In some embodiments, the central device may have independent internet connectivity and make requests (e.g., signing request, key generation request, etc.) to other peripheral devices. In contrast, one or more of the peripheral devices may lack independent internet connectivity and may simply respond to the central device's request. It should be understood that the invention is not limited to this configuration and one or more of the peripheral devices having internet connectivity (e.g., cloud or P2P network devices) is also possible and within the scope of the present disclosure. Each of the central device and the peripheral devices may store a respective key share of a private key. In some embodiments, the central device may not have a key share of its own and may be solely dedicated to coordinating the peripheral devices. These devices may collaborate through cryptographic protocols (e.g., MPC algorithms) to perform operations such as transaction signing, without reconstructing the private key in a single location. Since the private key is never fully assembled, even if one or more shares are compromised, the key remains secure. Also, because the central device and the peripheral devices are associated with a single user and within a close proximity (e.g., within a short range/distance) of each other, the user may perform a particular MPC function, such as cryptographic transaction signing or generating a key, on the go and/or remotely as compared to a traditional MPC system, where the user typically needs to be at a certain location or environment (e.g., home) in order to perform such a MPC function.

As discussed elsewhere herein, all or some of the peripheral devices of the MPC system discussed herein may be “cold” devices (i.e., offline or disconnected from the internet), thereby significantly reducing the attack surface. The idea is that even if a cyberattack comprises all the “hot” online nodes (e.g., a node corresponding to a central device having internet connectivity), the cyberattack would not be able to access the “cold” peripheral device(s) since they are not online. The offline nature of the peripheral device(s) enhances the overall security architecture by limiting the exposure of sensitive keys or data to online threats.

In particular embodiments, the central device may coordinate and/or communicate with one or more of the plurality of peripheral devices to perform a specific MPC function, such as signing a cryptographic transaction. For instance, the central device may register one or more peripheral devices of a plurality of peripheral devices. The one or more peripheral devices may be registered based on their respective device types (e.g., wearable devices). An optional spending rule may also be setup among the one or more peripheral devices based on a type of devices involved in MPC. Responsive to registering and optionally setting up the spending rule, the central device may send a request (e.g., key generation request, signing request) to each of the one or more peripheral devices to perform a specific MPC function (e.g., signing a cryptographic transaction). The central device may receive a confirmation (e.g., shareholder's approval) of the request from each of the one or more peripheral devices. And responsive to receiving the confirmation, the central device may perform the specific MPC function according to a specific MPC algorithm.

The following numbered examples represent embodiments of the present disclosure.

Example 1—a multi-party computation (MPC) system including a central device including a secure processing unit (SPU) configured to execute a plurality of MPC algorithms and process one or more MPC functions, and an MPC-enabled software application executable by the SPU to perform the one or more MPC functions according to a specific MPC algorithm; and a plurality of peripheral devices connected to the central device, each peripheral device including at least the MPC-enabled software application configured to perform the one or more MPC functions; wherein the central device is configured to: register one or more peripheral devices of the plurality of peripheral devices; send a request to each of the one or more peripheral devices to perform a specific MPC function; receive, from each of the one or more peripheral devices, a confirmation of the request; and perform the specific MPC function according to the specific MPC algorithm.

Example 2—the MPC system of Example 1, wherein the central device and the plurality of peripheral devices are associated with a single user.

Example 3—the MPC system of Example 2, wherein the plurality of peripheral devices is connected to the central device via Bluetooth or near-field communication (NFC).

Example 4—the MPC system of Example 2, wherein the central device is a smartphone; and the plurality of peripheral devices are wearables devices.

Example 5—the MPC system of Example 4, wherein the wearables devices include a smartwatch, a ring, earbuds, and eyeglasses.

Example 6—the MPC system of any one of Examples 1 to 5, wherein the plurality of peripheral devices is located within a short range of the central device.

Example 7—the MPC system of Example 1, wherein the request is a key generation request; and the specific MPC function includes each device generating a respective key share.

Example 8—the MPC system of Example 1, wherein the request is a signing request; and the specific MPC function includes each device signing a cryptographic transaction.

Example 9—the MPC system of Example 8, wherein the cryptographic transaction includes one of: spending a cryptocurrency associated with a first cryptocurrency wallet; transferring the cryptocurrency from the first cryptocurrency wallet to a second cryptocurrency wallet, executing a smart contract, and modifying a configuration or state of a smart contract.

Example 10—the MPC system of any one of Examples 1 to 9, wherein the central device is further configured to setup a spending rule among the plurality of peripheral devices, the spending rule specifying one or more conditions, wherein the signing request is rejected by the one or more peripheral devices when the one or more conditions of the spending rule are violated.

Example 11—the MPC system of Example 10, wherein the one or more conditions of the spending rule include: a maximum number of transactions that can be sent in a given time period; a total amount that can be sent in the given time period; and a list of addresses to which an asset can be sent.

Example 12—the MPC system of Example 1, wherein the central device is further configured to: assess a type of device of each of the plurality of peripheral devices; and register the one or more peripheral devices based on a particular type of the one or more peripheral devices.

Example 13—the MPC system of Example 12, wherein the type of device includes one of a cloud server; a device with dedicated hardware; a computing platform device; a wearable device; and a computing network device.

Example 14—the MPC system of Example 1, wherein the central device is further configured to: select a particular MPC configuration, wherein the particular MPC configuration comprises a T-of-N configuration, N representing a total number of devices including the central device and the plurality of peripheral devices, T representing a threshold number of devices required to perform the specific MPC function; and send MPC configuration details along with the request to each of the one or more peripheral devices, wherein the MPC configuration details comprises at least a list of devices involved in performing the specific MPC function.

Example 15—the MPC system of Example 14, wherein a peripheral device of the one or more peripheral devices is configured to: receive the request and the MPC configuration details from the central device; notify a user associated with the peripheral device of the request and the MPC configuration details; and send a response of the request to the central device.

Example 16—the MPC system of Example 15, wherein the response includes approving or declining the request.

Example 17—the MPC system of any one of Examples 1 to 16, wherein one or more of the plurality of peripheral devices include the SPU.

Example 18—the MPC system of Example 1, wherein the plurality of MPC algorithms comprises at least homomorphic-based cryptography algorithms and non-homomorphic-based cryptography algorithms; and the specific MPC algorithm is one of a homomorphic-based cryptography algorithm and a non-homomorphic-based cryptography algorithm.

Example 19—the MPC system of Example 18, wherein: the homomorphic-based cryptography algorithms are computation heavy algorithms; and the non-homomorphic-based cryptography algorithms are communication heavy algorithms.

Example 20—a multi-party computation (MPC) system including a central device including a secure processing unit (SPU) configured to execute a plurality of MPC algorithms and process one or more MPC functions, and an MPC-enabled software application executable by the SPU to perform the one or more MPC functions according to a specific MPC algorithm; and a plurality of peripheral devices connected to the central device, each peripheral device including the SPU configured to execute the plurality of MPC algorithms and process the one or more MPC functions, and the MPC-enabled software application configured to perform the one or more MPC functions; wherein the central device is configured to: register one or more peripheral devices of the plurality of peripheral devices; send a request to each of the one or more peripheral devices to perform a specific MPC function; receive, from each of the one or more peripheral devices, a confirmation of the request; and perform the specific MPC function according to the specific MPC algorithm.

### BRIEF DESCRIPTION OF THE DRAWINGS

FIG. 1 illustrates an example MPC environment.

FIG. 2A illustrates an example improved MPC system, according to particular embodiments.

FIG. 2B illustrates another example improved MPC system, according to particular embodiments.

FIG. 3 illustrates an example architecture of a secure processing unit.

FIGS. 4A and 4B illustrate two example embodiments illustrating example interactions between a micro-controller unit (MCU) and a hardware secure element (SE) for performing atomic inline operations used for MPC or other cryptographic operations.

FIG. 5 illustrates an example method for performing a specific MPC function.

FIG. 6 illustrates an example computer system on which embodiments described herein may be implemented.

### DESCRIPTION OF EXAMPLE EMBODIMENTS

MPC is an advanced cryptographic technique that enables multiple parties/devices to collaboratively compute a function over their inputs while keeping those inputs private from one another. MPC offers a decentralized approach to key management. In an MPC-based digital wallet, a private key is never created or stored as a whole entity. Instead, it is divided into shares, which are distributed among multiple parties or devices. Each share, on its own, reveals no information about the private key. These parties or devices can then collaborate through cryptographic protocols (e.g., MPC algorithms) to perform operations such as transaction signing, without reconstructing the private key in a single location. Since the private key is never fully assembled, even if one or more shares are compromised, the key remains secure.

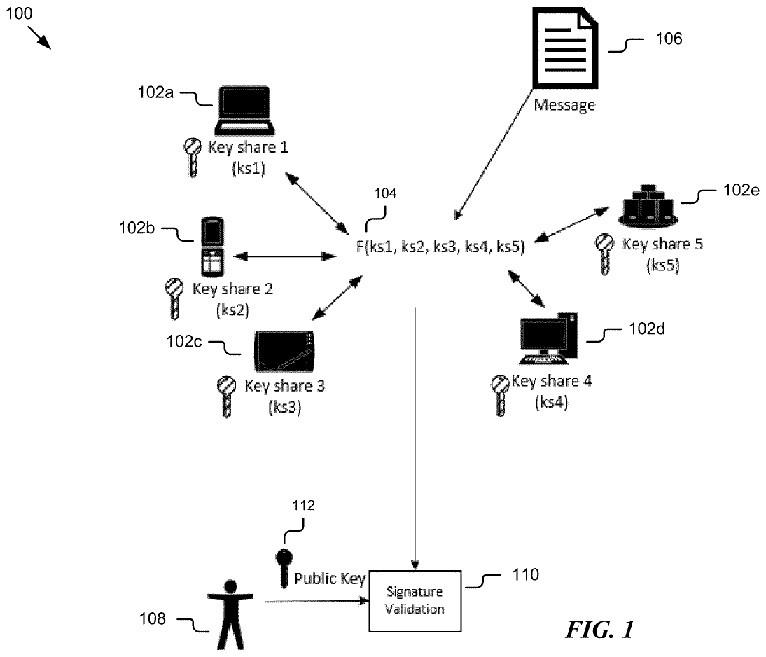

FIG. 1 illustrates an example MPC environment 100. As illustrated, the MPC environment 100 includes a plurality of devices 102a-102e, each having a respective key share of a private key. The devices 102a-102e may be associated with a single user or multiple users. The devices 102a-102e may jointly compute a function 104 and generate a signature on a message 106 using their respective key shares instead of the private key itself. The signature may be used for authentication or authorization. A user 108 may perform signature validation 110 (e.g., validate a signature) using his/her public key 112. In some embodiments, signature validation 110 may include processing and/or validating a zero-knowledge proof. In particular embodiments, a MPC algorithm (or MPC protocol) may be used by the devices 102a-102e to jointly compute the function 104, perform the signature validation 110, and sign a cryptographic transaction.

In particular embodiments, devices associated with a MPC, such as devices 102a-102e, may be categorized into different device categories by their respective types. For example, below table illustrates some example MPC device categories by different types.

| | | Dedicated | Computing | | |
|---|---|---|---|---|---|
| | Cloud | Hardware | Platform or | | Computing |
| | Servers | (HW) | environment | Wearables | Networks |
| Example | AWS, | HW | Mobile | Watches, | P2P |
| Devices | GCP, | crypto | phones, PC, | glasses, | networks, |
| | MS | wallets | tablets, | rings, | decentralized |
| | Azure | | browsers | earbuds | ledgers |
| Owner | Service | User | User | User | Typically |
| | provider | | | | decentralized, |
| | | | | | except some |
| | | | | | centralized |
| | | | | | networks |

In some embodiments, devices associated with a MPC, such as devices 102a-102e, may be categorized into different devices categories or types based on how they are authenticated. For example, computing devices, such as smartphones, laptops, tablets, desktop, etc., generally require passwords, PINs, security questions in order to gain or enable access to these devices. As another example, a USB device or a smart card requires proof of possession, such as clicking a button since these devices generally do not have a display. As a further example, some devices require biometrics (e.g., face scan/recognition, fingerprint match) in order to gain access to these devices.

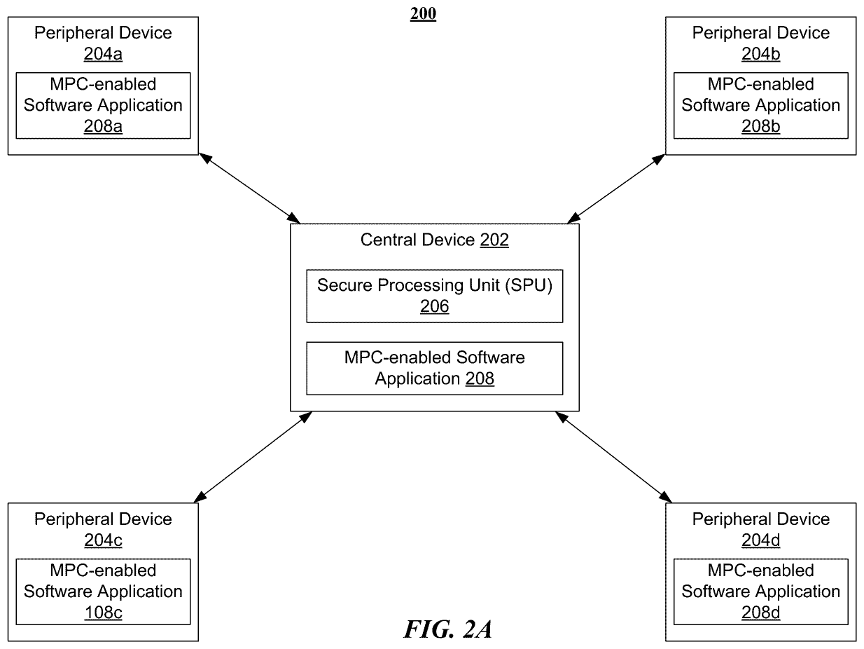

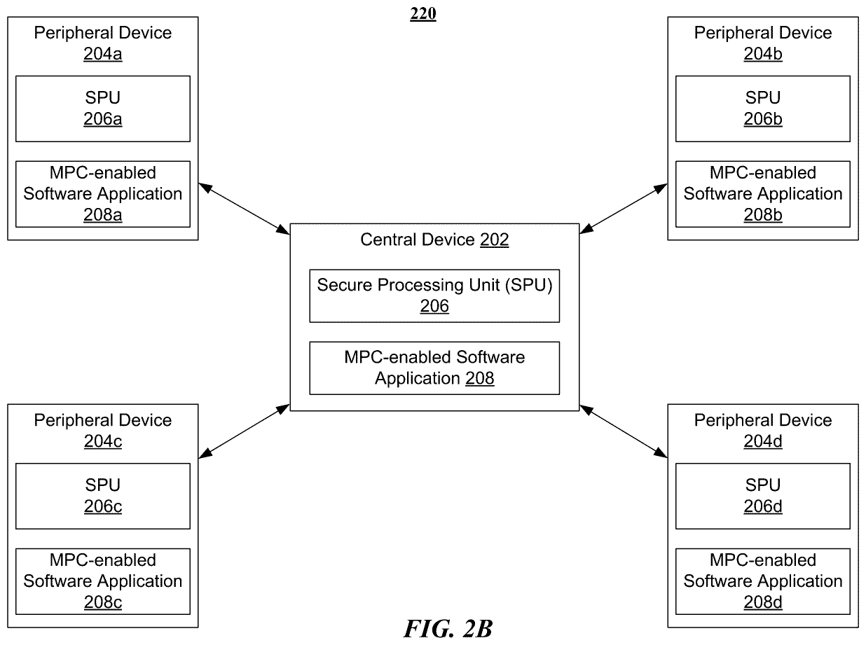

In particular embodiments, devices associated or involved in a MPC may be generally categorized into central and peripheral devices. For example, a MPC system may include a central device and a plurality of peripheral devices, such as ones depicted in FIGS. 2A and/or FIG. 2B. A central device typically has independent internet connectivity and make requests (e.g., signing request, key generation request, etc.) to other devices. Such a central device may include, for example and without limitation, a server, a BLE central, a USB host, a PC, a smart watch, etc. A peripheral device, on the other hand, often lacks independent internet connectivity, and responds to the central device's request. Such a peripheral device may include, for example and without limitation, a BLE peripheral device, a USB device, etc. In some embodiments, the central device may not have any MPC key shares of its own and may be solely dedicated to coordinating the peripheral devices connected to the central device. The central and peripheral devices that are involved in a MPC system discussed herein are now described in detail below in reference to at least FIGS. 2A and 2B.

FIG. 2A illustrates an example improved MPC system 200. The MPC system 200 includes a central device 202 and a plurality of peripheral devices 204a, 204b, 204c, and 204d (individually and/or collectively herein referred to as 204). Although, four peripheral devices 204 are shown in FIG. 2A and/or FIG. 2B, however, it should be understood that the MPC system is not limited by any way to these number of devices and that any number of peripheral devices are possible and within the scope of the present disclosure. The MPC system 200 may be configured for digital signatures (e.g., ECDSA, EdDSA) with T-of-N configuration, where T is threshold or minimum number of MPC shareholder devices that may be required to create a valid signature, and N is a total number of shareholder devices. The shareholder devices may be any devices regardless of their types, provided that N is at least greater than or equal to two devices, and at least one central-type device with internet connectivity must always exist to execute an MPC operation/function (e.g., key generation, signing). The MPC system 200 may be, for example and without limitation, a 3-of-5 system, which may include a cloud server, a mobile, a HW wallet, smart watch, and a browser extension, and at least 3 of these devices are required to perform a MPC operation. As another example, the MPC system 200 may be a 4-of-5 system, which may include a first cloud server, a second cloud server, a first mobile, a second mobile, and a smart ring, and at least 4 of these devices are required to perform a MPC operation. The MPC system may be MPC-algorithm-agnostic (e.g., not limited to specific algorithms).

In particular embodiments, the central device 202 and the peripheral devices 204 may be associated with a single user. By way of an example and without limitation, the central device 202 may be user's smartphone and the peripheral devices 204 may be user's wearable devices. For instance, peripheral device 204a may be a smart watch, peripheral device 204b may be a smart ring worn by the user on his/her finger, peripheral device 204c may be earbuds or headphones, and peripheral device 204d may be eyeglasses/frames. In particular embodiments, the central device 202 and the plurality of peripheral devices 204 may be located within a short range of each other. For example, the plurality of peripheral devices 204 may be connected to the central device 202 via Bluetooth or near-field communication (NFC) that enables the peripheral devices 204 to communicate with the central device 202 over short range or distances.

In some embodiments, as discussed above, the central device 202 may have independent internet connectivity and make requests (e.g., signing request, key generation request, etc.) to other peripheral devices 204. In contrast, one or more of the peripheral devices 204 may lack independent internet connectivity and may simply respond to the central device's request. In an alternative embodiment, one or more of the peripheral devices 204 discussed herein may have independent internet connectivity. For example, one or more peripheral devices 204 may be present on a cloud or a server and communicate with the central device 202 through a network, such as Internet. As another example, one or more of the peripheral devices 204 may be P2P network devices having internet connectivity. In such a scenario where peripheral device(s) 204 have internet connectivity, the peripheral device(s) 204 are similar to the central device 202, but they function as peripheral for the MPC operations discussed herein. Each of the central device 202 and the peripheral devices 204 may store a respective key share of a private key, as discussed, for example, in reference to FIG. 1. These devices 202 and 204 may collaborate through cryptographic protocols (e.g., MPC algorithms) to perform operations such as transaction signing, without reconstructing the private key in a single location. Since the private key is never fully assembled, even if one or more shares are compromised, the key remains secure. Also, because the central device 202 and the peripheral devices 204 are associated with a single user and within a close proximity (e.g., within a short range/distance) of each other, the user may perform a particular MPC function, such as cryptographic transaction signing or generating a key, on the go and/or remotely as compared to a traditional MPC system, where the user typically needs to be at a certain location or environment (e.g., home) in order to perform such a MPC function. For example, the traditional/existing MPC system typically consists of at least a cloud server comprising a hardware wallet and other devices. In such a system, to perform a MPC function, the user needs to be at a certain location to be able to access the cloud server and other devices to perform the MPC function. Also, all the devices involved in the traditional MPC system may be online (e.g., have internet connectivity) which makes them susceptible to online attacks. In contrast, all or some of the peripheral devices 204 of the MPC system 200 discussed herein may be “cold” devices (i.e., offline or disconnected from the internet), thereby significantly reducing the attack surface. The idea is that even if a cyberattack comprises all the “hot” online nodes (e.g., a node corresponding to a central device having internet connectivity), the cyberattack would not be able to access the “cold” peripheral device(s) since they are not online. The offline nature of the peripheral device(s) enhances the overall security architecture by limiting the exposure of sensitive keys or data to online threats.

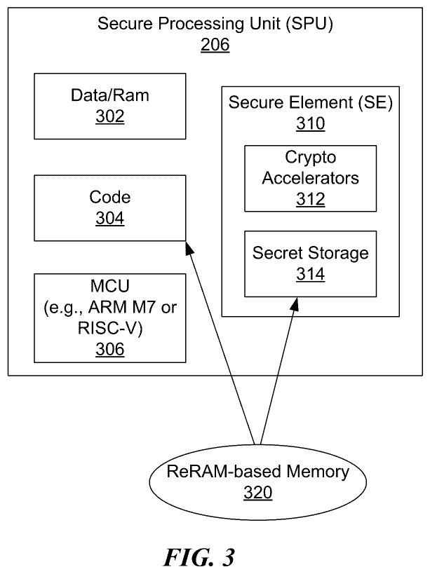

As depicted in FIGS. 2A and/or 2B, the central device 202 may include a secure processing unit (SPU) 206 and an MPC-enabled software application 208. The SPU 206 may be configured to store key share(s), execute a plurality of MPC algorithms, and process one or more MPC functions/computations (e.g., transaction signing, key generation) discussed herein. The MPC algorithms may include, for example and without limitation, homomorphic cryptography-based algorithms (e.g., GG18, GG20, CGGMP21, etc.) and non-homomorphic cryptography-based algorithms (e.g., DKLs19, DKLs23, etc.). The homomorphic cryptography-based algorithms are generally computation-heavy algorithms and are suitable for transactions involving higher computational requirements and/or devices with strong computational power. In contrast, non-homomorphic cryptography-based algorithms are communication-heavy algorithms and are suitable for transactions involving a lot of communication between the devices involved in the MPC. In particular embodiments, the SPU 206 integrates a micro-controller unit (MCU) (e.g., ARM M7, RISC-V) and a hardware secure element (SE) into a single monolithic chip, which enhances overall security and enables faster MPC computations. The SPU 206 is shown and described in detail below in reference to FIG. 3.

As depicted in FIGS. 2A and/or 2B, the central device 202 may further include an MPC-enabled software application 208. The MPC-enabled software application 208 is an MPC-specific application that is executable by the SPU 206 to perform the one or more MPC functions/operations (e.g., transaction signing, key generation) according to a specific MPC algorithm. In particular embodiments, the MPC-enabled software application 208 may be downloaded from an application store. As depicted, the peripheral devices 204 may also include an instance of the MPC-enabled software application 208. In particular embodiments, each peripheral device 204 may include a specific instance or version of the MPC-enabled software application 208 that is custom tailored or developed according to a specific type of the peripheral device 204. For instance, the peripheral device 204a may include an MPC-enabled software application 208a according to a type of the peripheral device 204a, the peripheral device 204b may include a MPC-enabled software application 208b according to a type of the peripheral device 204b, the peripheral device 204c may include a MPC-enabled software application 208c according to a type of the peripheral device 204c, and the peripheral device 204d may include a MPC-enabled software application 208d according to a type of the peripheral device 204d. By way of an example and without limitation, if the peripheral device 204a is a smartwatch, then the MPC-enabled software application 208a may be specifically designed and/or developed to run on the smartwatch. Each of these instances of MPC-enabled software application 208a, 208b, 208c, and 208d may be downloaded from an application store.

In some embodiments, one or more of the peripheral devices 204a may additionally include the SPU 206. FIG. 2B illustrates another example improved MPC system 220 including a central device 202 and a plurality of peripheral devices 204. Here, as depicted, each of the peripheral devices 204 may additionally include a specific instance or version of the SPU 206 that is custom manufactured or designed according to a specific type of the peripheral device 204. For instance, the peripheral device 204a may include a SPU 206a that is manufactured and/or built for a type of the peripheral device 204a, the peripheral device 204b may include a SPU 206b that is manufactured and/or built for a type of the peripheral device 204b, the peripheral device 204c may include a SPU 206c that is manufactured and/or built for a type of the peripheral device 204c, and the peripheral device 204d may include a SPU 206d that is manufactured and/or built for a type of the peripheral device 204d. As discussed elsewhere herein, each of SPU 206a-206d may be configured to store key share(s), execute a plurality of MPC algorithms, and process one or more MPC functions/computations (e.g., transaction signing, key generation) discussed herein. The SPU 206 is described in detail below in reference to FIG. 3.

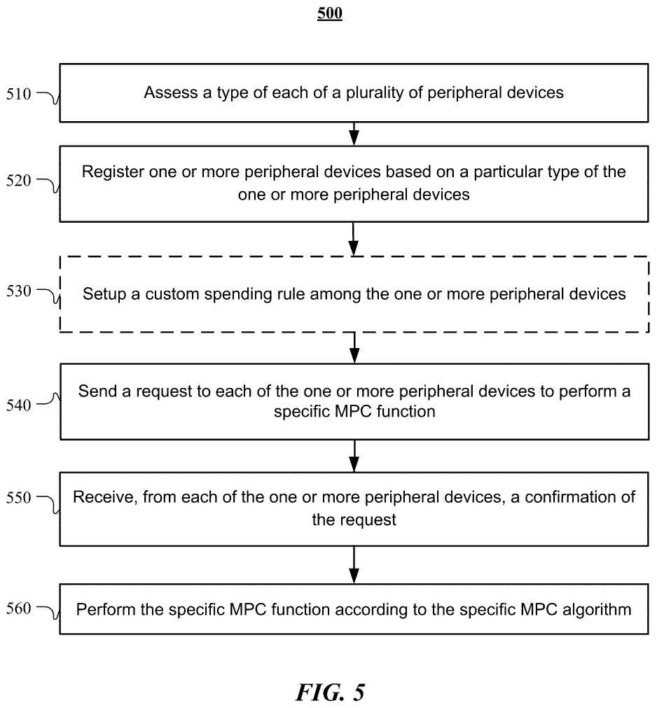

In particular embodiments, the central device 202 may coordinate and/or communicate with one or more of the plurality of peripheral devices 204 to perform a specific MPC function, such as signing a cryptographic transaction. FIG. 5, discussed later in detail below, illustrates example steps that may be performed by the central device 202 to perform the specific MPC function.

At a high level, to perform a specific MPC operation/function (e.g., transaction signing), the central device 202 (e.g., user's smartphone) may be configured to first register one or more of the peripheral devices 204 (e.g., wearable devices) to the central device 202. In some embodiments, registering may be based on a type of one or more of the peripheral devices 204. For instance, the central device 202 may assess a type of each of the plurality of peripheral devices 204 and register one or more peripheral devices of the plurality based on a particular type (e.g., wearable device type) of the one or more peripheral devices. Once registered, the central device 202 may send a request to the registered device(s) to perform a specific MPC function. For example, the request may be a key generation request and the specific MPC function may include each device generating a respective key share. As another example, the request may be a signing request and the specific MPC function may include each device signing a cryptographic transaction, which may include, for example, spending a cryptocurrency (e.g., Bitcoin) associated with a first cryptocurrency wallet or transferring the cryptocurrency from the first cryptocurrency wallet to a second cryptocurrency wallet.

In particular embodiments, in addition to sending the request, the central device 202 may also send MPC configuration details to each of the one or more registered devices. The MPC configuration details may include, for example, a list of devices involved in performing the specific MPC function associated with the request. For instance, the central device 202 may select a particular MPC configuration, where the particular MPC configuration may include a T-of-N configuration, N representing a total number of devices including the central devices and the plurality of peripheral devices and T representing a threshold number of devices required to perform the specific MPC function. The MPC configuration details along with the request may be sent to each registered peripheral device. A registered peripheral device may be configured to receive the request and the MPC configuration details from the central device 202, notify a user associated with the registered peripheral device of the request and the MPC configuration details, and a send a response of the request back to the central device 202. The response may include an approval or decline of the request. Upon the central device 202 receiving a confirmation (e.g., approval) from each of the registered peripheral devices, the central device 202 may perform the specific MPC function according to a specific MPC algorithm. The central device 202 and peripheral devices 204 are now discussed with two example MPC functions/operations below.

For key generation, a user starts with the main central device (e.g., central device 202), which could be a mobile device or PC. The user registers other devices (e.g., one or more peripheral devices 204) to the main central device. This may include, for example, connecting a HW wallet to the central device, paring a Bluetooth capable non-central device to the central device (e.g., smart watch paired with the mobile), selecting a specific cloud to work with the main central device. The main central device (e.g., central device 202) sends MPC configurations along with a key generation request to each device, and if applicable, a user confirmation is required in each device. For example, a smart watch displays T-of-N configuration with the MPC group member list (e.g., list of all shareholders) and a user confirms it. As another example, a device without a display may require a simple user response upon request such as clicking a button on a USB device. Decentralized key generation is performed according to specific selected MPC algorithm(s). The devices without internet connectivity may rely on a central device to communicate with other devices.

For signing, a user starts with a central device (e.g., central device 202) and decides which other devices (e.g., one or more peripheral devices 204) to use for the signing. The central device sends the signing request to the selected devices (e.g., selected MPC signers). The signing request may include, for example and without limitation, asset information (e.g., BTC), amount, recipient address, signer lists, etc. The recipient user is required to confirm the signing request on each device e.g., authentication, proof-of-possession. The MPC shareholders perform the signing process according to the MPC algorithm implemented.

In some embodiments, an optional spending rule may be setup among the shareholder devices. The spending rule may be a function of signing the MPC shareholders. The spending rule may specify one or more conditions, which may include, for example, a maximum number of transaction and total amount that may be sent in a given time period, whitelist addresses to which an asset may be sent, etc. The spending rule may be stored in at least all central devices (or all devices for more security). Any signing request that violates the one or more conditions of the spending rule will be rejected by each device. By way of an example and without limitation, in a 2-of-4 MPC system with mobile, cloud. HW wallet, and smart watch, a spending rule of $1000 limit/day may be setup when HW wallet is not selected as a signer. A user will be given more trust and a higher spending limit may be allowed when a HW wallet is used.

MPC takes multiple shares and computes a valid signature, but that process is computationally heavy. Performing such computations in software on a general processing unit could take 10 or more seconds, which is unacceptable in many use cases. Thus, in order for MPC to be practical, hardware silicon support is needed. To address this problem and to securely and efficiently process MPC, a secure processing unit (SPU) 206 is presented herein. FIG. 3 illustrates an example architecture of a SPU 206. As discussed elsewhere herein, the SPU 206 may be present in a central device of a MPC system, such as the central device 202. Additionally, the SPU 206 may be present in one or more peripheral devices of the MPC system, such as peripheral devices 204, as shown in FIG. 2B. As illustrated in FIG. 3, the SPU 206 integrates all components, including a data/ram 302, code 304, a micro-controller unit (MCU) 306, and a hardware secure element (SE) 310 including crypto accelerators 312 and a secure storage 314 into a single monolithic chip. One or more keys and/or key shares discussed herein may be stored in the secret storage 314 of the SE 310. With the MCU 306 and the secure storage 314 being on the same chip and protected within same Physical Countermeasure Mechanisms (PCM) shield, messages between the two are hidden and secured. Having the MCU protected within the PCM also enhances security, since the MCU 306 is responsible for computing signatures and controlling the user interface (UI) used for approving transactions. If the UI is not protected, the assets can be compromised even if the keys are not. Therefore, protecting the MCU 306 is important to reduce attack surfaces.

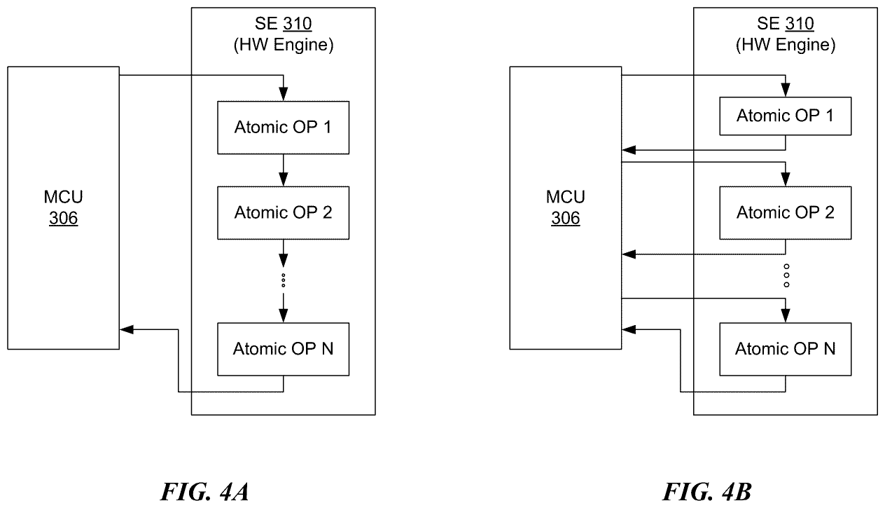

In particular embodiments, the SE 310 within the SPU 206 may be configured to support atomic inline operations used for MPC or other cryptography operations. FIGS. 4A and 4B illustrate two example embodiments illustrating example interactions between a MCU 306 and a SE 310 for performing atomic inline operations used for MPC or other cryptographic operations. For example, as shown in FIG. 4A, the MCU 306 issues a command, and the SE 310, operating as a state machine, autonomously processes the entire protocol inline without further coordination from the MCU 306. Sensitive data remains confined within the SE 310 and is never exposed to the MCU 306. Only the results of the operations are sent back to the MCU 306. This mode provides a robust additional layer of defense, with the SE 310 managing the complete protocol independently for highly secure and streamlined operations.

In another embodiment shown in FIG. 4B, the SE 310 does not support full protocol acceleration. In this case, the SE 310 performs atomic operations, which the MCU 306 coordinates to construct custom protocols. Although the MCU 306 plays a more active role in this mode, sensitive data is still not exposed to the MCU 306, as all critical data handling occurs securely within the SE 310. This approach allows for greater flexibility, enabling the implementation of arbitrary protocols while maintaining security.

The two modes offer a balance between flexibility and security. The shared PCM shield ensures the integrity of both the MCU 306 and SE 310, making either mode a secure solution for modern applications requiring customizable and protected cryptographic operations.

Aside from enhanced security, having the integrated components on a single chip allows the SPU 206 to achieve superior cost, power, and size. Instead of flash memory, the solution uses ReRAM-based memory 320 which provides greater reliability and performance.

Additionally, as previously mentioned, the solution incorporates cryptographic primitives tailored to modern blockchain applications, ensuring its relevance and adaptability.

In particular embodiments, the SPU 206 may be built using a cutting-edge 2×nm (e.g., 22 nm), 1×nm (e.g., 18 nm) or sub-10 nm manufacturing process, providing superior cost efficiency, lower power consumption, reduced size, and enhanced security compared to SEs typically manufactured at 40-130 nm. The SPU 206 employs ReRAM 320 instead of floating gate flash, making it more robust against temperature, aging, radiation, and magnetic fields. It integrates a PMIC with an LDO regulator, enabling efficient operation from a 2.7-3.6V supply range.

A notable feature is its external memory interface, supporting execute-in-place (XIP) operations with external flash (QSPI, OSPI) and SRAM (HSPI), while offering real-time encryption and decryption of external memory traffic-capabilities not found in typical SEs, which lack external memory support altogether. The dual-processor architecture of the MCU 306 may combine RISC-V and ARM M7 cores, significantly outperforming SEs, which typically use a single low-performance core (e.g., ARM MO-M3). As such, the SPU 206 delivers faster processing speeds, higher clock rates due to advanced pipelining, and enhanced memory capabilities, including larger NVM (4 MB) and SRAM (2 MB), along with advanced caching and tightly coupled memory.

For efficient data transfer, the SPU 206 features a dedicated I/O bus with DMA and buffer memory for high-speed operations, a main DMA controller on an advanced multi-port AXI bus, and an AXI architecture superior to the simpler AHB-like buses used in SEs. These advancements collectively enhance performance, flexibility, and security, making the SPU 206 a robust solution for modern secure applications.

### Example Method

FIG. 5 illustrates an example method 500 for performing a specific MPC function. In particular, the method 500 illustrates steps that may be performed by a central device (e.g., central device 202) in communication and/or coordination with a plurality of peripheral devices (e.g., peripheral devices 204) to perform a specific MPC function/operation. As discussed elsewhere herein, the central device and the plurality of peripheral devices may be associated with a single user, where the plurality of peripheral devices may be connected to the central device via Bluetooth or NFC. For example, the central device may be user's mobile device, such as a smartphone, and the plurality of peripheral devices may be wearable devices, such as, a smartwatch, a ring, earbuds, and eyeglasses. In particular embodiments, the central device has internet connectivity and one or more of the plurality of peripheral devices may lack internet connectivity making these peripheral devices as cold devices.

As shown and discussed in reference to FIGS. 2A and/or 2B, the central device 202 may include a SPU 206, which may be configured to execute a plurality of MPC algorithms and process one or more MPC functions discussed herein. The SPU 206 may integrate a MCU 306 and a hardware secure element 310 on a single chip, as shown and discussed in reference to FIG. 3. The central device 202 may also include an MPC-enabled software application 208, which may be executable by the SPU 206 to perform the one or more MPC functions according to a specific MPC algorithm. Each of the plurality of peripheral devices 204 may also include an instance of the MPC-enabled software application 208, as shown and discussed in reference to FIG. 2A. In some embodiments, one or more of the peripheral devices 204 may additionally include an instance of the SPU 206, as shown and discussed in reference to FIG. 2B.

In particular embodiments, the steps 510-560 illustrated in FIG. 5 may be performed by the MPC-enabled software application 208 running on the central device 202 and executed by the SPU 206 present on the central device 202. The MPC-enabled software application 208 of the central device 202 may coordinate and/or communicate with a respective MPC-enabled software application 208a-208d of a peripheral device 204a-204d to perform the steps 510-560. Each of the steps 510-506 is now discussed in detail below.

At block 510, the central device 202 may assess a type of each of a plurality of peripheral devices 204. The type of device may be one of a cloud server (e.g., AWS, GCP, MS Azure, etc.), a device with dedicated hardware (e.g., HW crypto wallets), a computing platform device (e.g., mobile phone, PC, tablet, browser), a wearable device (e.g., watches, glasses, rings, earbuds), and a computing network device (e.g., P2P networks, decentralized ledgers, etc.).

At block 520, the central device 202 may register one or more peripheral device 204 based on a particular type of the one or more peripheral devices 204. For example, the central device 204 may register wearable devices carried by a user.

At block 530, the central device 202 may optionally setup a custom spending rule among the one or more peripheral devices. For instance, if the central device and the one or more peripheral devices are involved in a transaction signing, then a spending rule that is a function of signing MPC shareholders may be setup. The spending rule may specify one or more conditions and if the one or more conditions of the spending rule are violated, then a signing request is rejected by each device involved. These conditions may include, for example and without limitation, a maximum number of transactions that can be sent in a given time period, a total amount that can be sent in the given time period, a list of addresses (e.g., whitelist addresses) to which an asset can be sent, etc. The custom spending rule may be based on different device types associated with the central device and the one or more peripheral devices. For example, a lower spending rule may be set when no HW wallet is involved and/or the HW wallet is not selected as a signer. In contrast, a higher spending rule may be set when a HW wallet is used.

At block 540, the central device 202 may send a request to each of the one or more peripheral devices 204 to perform a specific MPC function. In one embodiment, the request may be a key generation request and the specific MPC function may include each device generating their respective key share. In another embodiment, the request may be a signing request and the specific MPC function may include each device signing a cryptographic transaction. The cryptographic transaction may include, for example and without limitation, spending a cryptocurrency (e.g., Bitcoin) associated with a first cryptocurrency wallet or transferring the cryptocurrency from the first cryptocurrency wallet to a second cryptocurrency wallet. As discussed elsewhere herein, a spending rule may be associated with the signing request.

In particular embodiments, the central device 202 may send MPC configuration details along with the request (e.g., key generation request, signing request) to the one or more peripheral devices 204. For instance, the central device 202 may select a particular MPC configuration, where the particular MPC configuration may include a T-of-N configuration, N representing a total number of devices including the central devices and the plurality of peripheral devices and T representing a threshold number of devices required to perform the specific MPC function. MPC configuration details along with the request may be sent to each of the one or more peripheral devices. The MPC configuration details may include at least a list of devices involved in performing the specific MPC function.

Upon receiving the request and the MPC configuration details from the central device, a peripheral device 204 may be configured to notify a user associated with the peripheral device of the request and the MPC configuration details and send a response of the request back to the central device. The response may include approving or declining the request. For example, if one or more conditions of the spending rule are violated, then the peripheral device may decline the signing request.

At block 550, the central device 202 may receive from each of the one or more peripheral devices 204 that it registered, a confirmation (e.g., user's approval) of the request. Responsive to receiving the confirmation, the central device 202, at block 560, may perform the specific MPC function (e.g., signing a cryptographic transaction) according to a specific MPC algorithm. The specific MPC algorithm may be one of homomorphic-based cryptography algorithm or a non-homomorphic-based cryptography algorithm. The homomorphic-based cryptography algorithm is a computation heavy algorithm, whereas the non-homomorphic-based cryptography algorithm is a communication heavy algorithm.

Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for performing a specific MPC function, including the particular steps of the method of FIG. 5, this disclosure contemplates any suitable method for performing a specific MPC function, including any suitable steps, which may include a subset of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

### Example Computer System

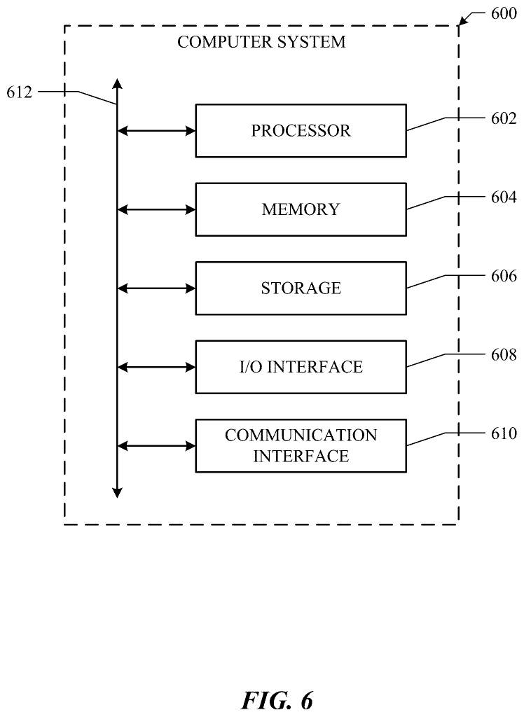

FIG. 6 illustrates an example computer system 600. In particular embodiments, one or more computer systems 600 perform one or more steps of one or more processes, algorithms, techniques, or methods described or illustrated herein. In particular embodiments, one or more computer systems 600 provide the functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A multi-party computation (MPC) system comprising:
a central device comprising a secure processing unit (SPU) configured to execute a plurality of MPC algorithms and process one or more MPC functions, and an MPC-enabled software application executable by the SPU to perform the one or more MPC functions according to a specific MPC algorithm; and
a plurality of peripheral devices connected to the central device, each peripheral device comprising at least the MPC-enabled software application configured to perform the one or more MPC functions;
wherein the central device is configured to:
register one or more peripheral devices of the plurality of peripheral devices;
send a request to each of the one or more peripheral devices to perform a specific MPC function;
receive, from each of the one or more peripheral devices, a confirmation of the request; and
perform the specific MPC function according to the specific MPC algorithm.

2. The MPC system of claim 1, wherein the central device and the plurality of peripheral devices are associated with a single user.

3. The MPC system of claim 2, wherein the plurality of peripheral devices is connected to the central device via Bluetooth or near-field communication (NFC).

4. The MPC system of claim 2, wherein:
the central device is a smartphone; and
the plurality of peripheral devices are wearables devices.

5. The MPC system of claim 4, wherein the wearables devices comprise a smartwatch, a ring, earbuds, and eyeglasses.

6. The MPC system of claim 1, wherein the plurality of peripheral devices is located within a short range of the central device.

7. The MPC system of claim 1, wherein:
the request is a key generation request; and
the specific MPC function comprises each device generating a respective key share.

8. The MPC system of claim 1, wherein:
the request is a signing request; and
the specific MPC function comprises each device signing a cryptographic transaction.

9. The MPC system of claim 8, wherein the cryptographic transaction comprises one of:
spending a cryptocurrency associated with a first cryptocurrency wallet;
transferring the cryptocurrency from the first cryptocurrency wallet to a second cryptocurrency wallet;
executing a smart contract; and
modifying a configuration or state of a smart contract.

10. The MPC system of claim 8, wherein the central device is further configured to:
setup a spending rule among the plurality of peripheral devices, the spending rule specifying one or more conditions,
wherein the signing request is rejected by the one or more peripheral devices when the one or more conditions of the spending rule are violated.

11. The MPC system of claim 10, wherein the one or more conditions of the spending rule comprise:
a maximum number of transactions that can be sent in a given time period;
a total amount that can be sent in the given time period; and
a list of addresses to which an asset can be sent.

12. The MPC system of claim 1, wherein the central device is further configured to:
assess a type of device of each of the plurality of peripheral devices; and
register the one or more peripheral devices based on a particular type of the one or more peripheral devices.

13. The MPC system of claim 12, wherein the type of device comprises one of:
a cloud server;
a device with dedicated hardware;
a computing platform device;
a wearable device; and
a computing network device.

14. The MPC system of claim 1, wherein the central device is further configured to:
select a particular MPC configuration, wherein the particular MPC configuration comprises a T-of-N configuration, N representing a total number of devices including the central device and the plurality of peripheral devices, T representing a threshold number of devices required to perform the specific MPC function; and
send MPC configuration details along with the request to each of the one or more peripheral devices,
wherein the MPC configuration details comprises at least a list of devices involved in performing the specific MPC function.

15. The MPC system of claim 14, wherein a peripheral device of the one or more peripheral devices is configured to:
receive the request and the MPC configuration details from the central device;
notify a user associated with the peripheral device of the request and the MPC configuration details; and
send a response of the request to the central device.

16. The MPC system of claim 15, wherein the response comprises approving or declining the request.

17. The MPC system of claim 1, wherein one or more of the plurality of peripheral devices comprise the SPU.

18. The MPC system of claim 1, wherein:
the plurality of MPC algorithms comprises at least homomorphic-based cryptography algorithms and non-homomorphic-based cryptography algorithms; and
the specific MPC algorithm is one of a homomorphic-based cryptography algorithm and a non-homomorphic-based cryptography algorithm.

19. The MPC system of claim 18, wherein:
the homomorphic-based cryptography algorithms are computation heavy algorithms; and
the non-homomorphic-based cryptography algorithms are communication heavy algorithms.

20. A multi-party computation (MPC) system comprising:
a central device comprising a secure processing unit (SPU) configured to execute a plurality of MPC algorithms and process one or more MPC functions, and an MPC-enabled software application executable by the SPU to perform the one or more MPC functions according to a specific MPC algorithm; and
a plurality of peripheral devices connected to the central device, each peripheral device comprising the SPU configured to execute the plurality of MPC algorithms and process the one or more MPC functions, and the MPC-enabled software application configured to perform the one or more MPC functions;
wherein the central device is configured to:
register one or more peripheral devices of the plurality of peripheral devices;
send a request to each of the one or more peripheral devices to perform a specific MPC function;
receive, from each of the one or more peripheral devices, a confirmation of the request; and
perform the specific MPC function according to the specific MPC algorithm.
